(19) United States
(12) Patent Application Publication
(10) Pub. No.: US 2025/0229268 A1
(43) Pub. Date: Jul. 17, 2025

(54) CONTAINER, MICROFLUIDIC DEVICE, AND DIAPHRAGM PUMP

(71) Applicant: NOK CORPORATION, Tokyo (JP)

(72) Inventor: Akira FUNAHASHI

(21) Appl. No.: 18/702,746

(22) PCT Filed: Dec. 7, 2022
(86) PCT No.: PCT/JP2022/045153

§ 371 Date: Apr. 18, 2024

(30) Foreign Application Priority Data
Jan. 11, 2022 (JP) 2022002153

(51) Int. Cl. B01L 3/00; B01F 33/00; F04B 43/04

(52) U.S. Cl. CPC B01L 3/502715; B01F 33/00; B01L 3/523; F04B 43/043; B01L 2300/041; B01L 2300/0672; B01L 2300/0816; B01L 2300/123; B01L 2400/0481; B01L 2400/0683

(57) ABSTRACT

Provided are a container with which the outflow rate of a fluid can easily be controlled, and which can be caused to function as part of a configuration of a diaphragm pump, as well as a microfluidic device and a diaphragm pump. The container includes a case body 110 that includes a tubular portion in which a fluid is to be sealed, a thin film 200 that closes an opening on one end side of the tubular portion and that is to be punctured so as to form an outflow port for the fluid R therein, and a diaphragm 300 that closes an opening on the other end side of the tubular portion.

### CROSS-REFERENCE TO RELATED APPLICATIONS

This application is a National Stage of International Application No. PCT/JP2022/045153, filed Dec. 7, 2022 (now WO 2023/135991 A1), which claims priority to Japanese Application No. 2022-002153, filed Jan. 11, 2022. The entire disclosures of each of the above applications are incorporated herein by reference.

### FIELD

The present disclosure relates to a container, a microfluidic device, and a diaphragm pump.

### BACKGROUND

In a known conventional technique relating to a microfluidic device that uses a microfluidic chip, a small flow passage and a reaction vessel are provided in a small chip, and a reaction process and so on are implemented using a small amount of reagent. According to this technique, a test that uses an expensive reagent can be performed using a small amount of the reagent. Another known technique relates to a container in which a fluid such as a reagent that is supplied to a microfluidic chip is sealed.

With a container having a conventional structure, however, it is difficult to control the flow rate of the fluid, such as the reagent supplied to the microfluidic chip. Moreover, the only function of a container having a conventional structure is as a container for housing a fluid.

### Citation List

### Patent Literature

[PTL 1] Japanese Patent Application Publication No. H9-175538
[PTL 2] Japanese Patent Application Publication No. 2017-121970

### SUMMARY

### Technical Problem

The present disclosure provides a container with which the outflow rate of a fluid can easily be controlled, and which can be caused to function as part of a configuration of a diaphragm pump, as well as a microfluidic device and a diaphragm pump.

### Solution to Problem

To solve the problems described above, the present disclosure employs the following means.

A container of the present disclosure includes: a case body that includes a tubular portion in which a fluid is to be sealed; a thin film that closes an opening on one end side of the tubular portion, and that is to be punctured so as to form an outflow port for the fluid therein; and a diaphragm that closes an opening on the other end side of the tubular portion.

According to the present disclosure, by pressing the diaphragm in a state where the outflow port has been formed in the thin film, the fluid sealed inside the case body can be caused to flow out. Further, since the fluid is caused to flow out by pressing the diaphragm, the outflow rate of the fluid can easily be controlled. Furthermore, the container can also be caused to function as part of a diaphragm pump.

On the other end side of the case body, a lid that closes off the diaphragm from an outside space may be provided on a side opposite to the thin film with respect to the diaphragm.

This prevents the diaphragm from being exposed to the outside during storage or transportation of the container.

The lid may be provided integrally with the case body, a boundary between the lid and the case body may be constituted by a thin part, and the lid may be removable from the case body by tearing the thin part.

Thus, by removing the lid from the case body, the fluid can be supplied to a microfluidic chip or the like, and the container can be used as a diaphragm pump.

A handle to be pulled to tear the thin part may be provided on the lid.

This allows the lid to be easily removed from the case body.

Further, the case body may be formed from a material having a gas barrier property.

Furthermore, the thin film may be formed from a material having a gas barrier property.

Moreover, the diaphragm may be formed from an elastomer material.

The container can be attached to a microfluidic chip that includes an attachment portion to which the case body is attached, a projecting portion for puncturing the thin film, and a flow passage for the fluid.

The thin film may be sandwiched between a first guide member and a second guide member, each of which has a through hole through which the projecting portion is inserted, the first guide member being provided on the diaphragm side and the second guide member being provided on a side opposite to the first guide member with respect to the thin film.

Thus, when the container is attached to the microfluidic chip, positional deviation of the projecting portion can be suppressed by the through holes, and as a result, the operation for puncturing the thin film with the projecting portion can be performed smoothly.

The fluid may be sealed in a space between the diaphragm and the first guide member, and a surface of the first guide member on the diaphragm side may be constituted by an inclined surface that decreases in diameter toward the through hole.

This prevents the fluid from remaining inside the container when the diaphragm is pressed such that the fluid flows out.

The first guide member may be formed from a hard material and the second guide member may be formed from an elastomer material.

This enhances a function of the first guide member as a guide for suppressing positional deviation of the projecting portion, and a function of the second guide member for suppressing leakage of the fluid to the outside.

Furthermore, a guide member having a through hole through which the projecting portion is inserted may be provided between the case body and the thin film, the fluid may be sealed in a space between the diaphragm and the guide member, and a surface of the guide member on the diaphragm side may be constituted by an inclined surface that decreases in diameter toward the through hole.

Further, a microfluidic device according to the present disclosure may include: a microfluidic chip including an attachment portion to which the case body is attached, a projecting portion for puncturing the thin film, and a flow passage for the fluid; and the container described above, which is attached to the microfluidic chip by attaching the case body to the attachment portion.

Furthermore, a diaphragm pump according to the present disclosure may include: the microfluidic device described above; a pressing member configured to press the diaphragm; and an actuator configured to cause the pressing member to perform a reciprocating motion.

Note that the configurations described above may be employed in any possible combinations.

### Advantageous Effects of the Disclosure

According to the present disclosure, as described above, it is possible to provide a container with which the outflow rate of a fluid can easily be controlled, and which can be caused to function as part of the configuration of a diaphragm pump, as well as a microfluidic device and a diaphragm pump.

### BRIEF DESCRIPTION OF DRAWINGS

FIGS. 1A and 1B are schematic views of a container according to a first embodiment of the present disclosure.

FIG. 2 is a schematic sectional view of the container according to the first embodiment of the present disclosure.

FIGS. 3A and 3B are schematic views showing the container in use according to the first embodiment of the present disclosure.

FIGS. 4A and 4B are schematic views of a microfluidic chip to which the container according to the first embodiment of the present disclosure can be applied.

FIGS. 5A and 5B are schematic views of a microfluidic device and a diaphragm pump to which the container according to the first embodiment of the present disclosure can be applied.

FIGS. 6A and 6B are schematic views of a microfluidic device and a diaphragm pump to which the container according to the first embodiment of the present disclosure can be applied.

FIG. 7 is a schematic sectional view of a container according to a second embodiment of the present disclosure.

FIG. 8 is a schematic sectional view of a container according to a third embodiment of the present disclosure.

### DETAILED DESCRIPTION

Exemplary forms to implement the disclosure will be described in detail below with reference to the figures on the basis of embodiments. Note, however, that unless specifically indicated otherwise, the scope of the disclosure is not limited only to the dimensions, materials, shapes, relative arrangements, and so on of the constituent components described in the embodiments.

### First Embodiment

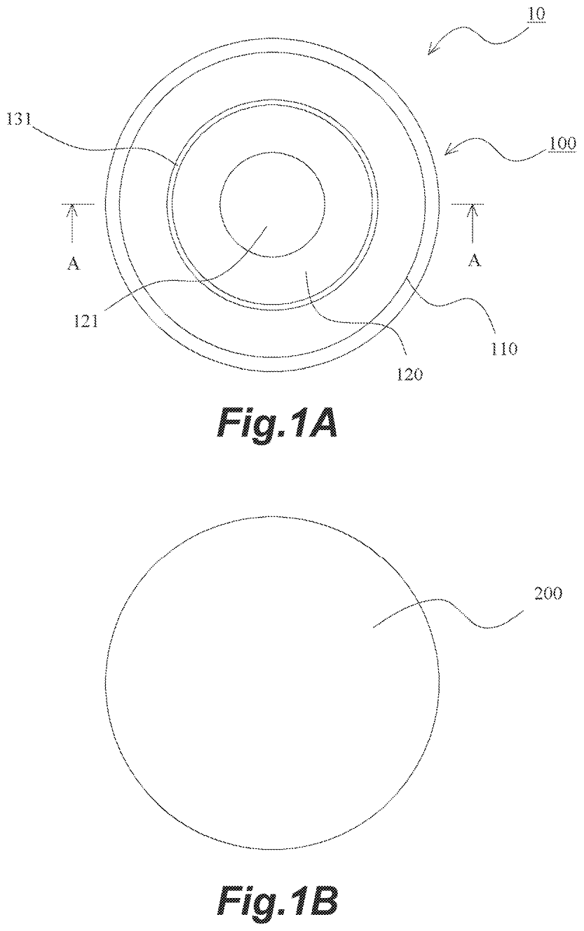

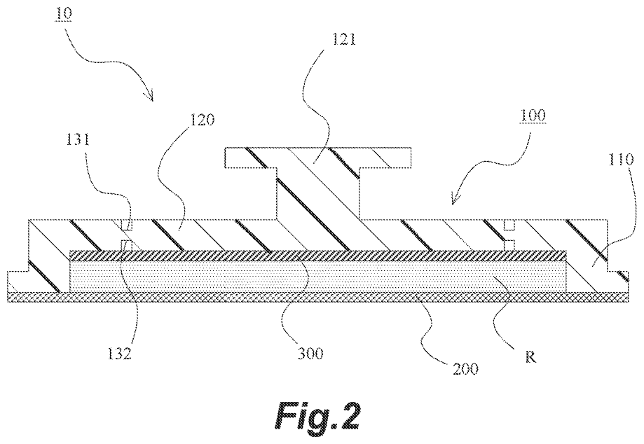

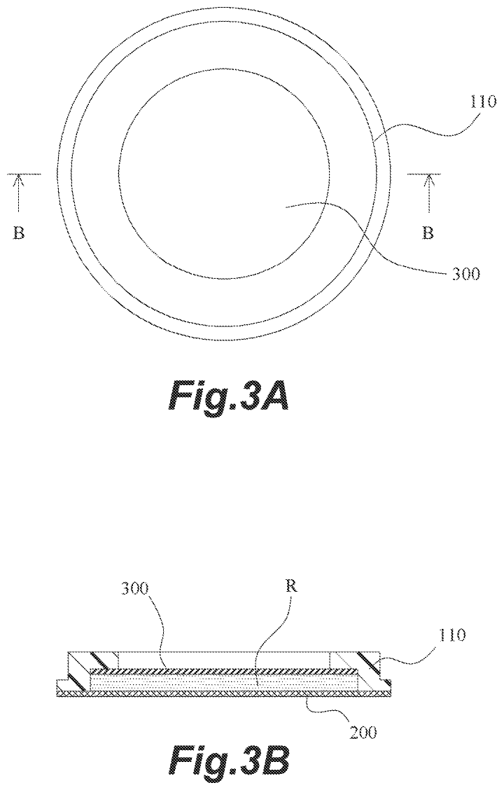

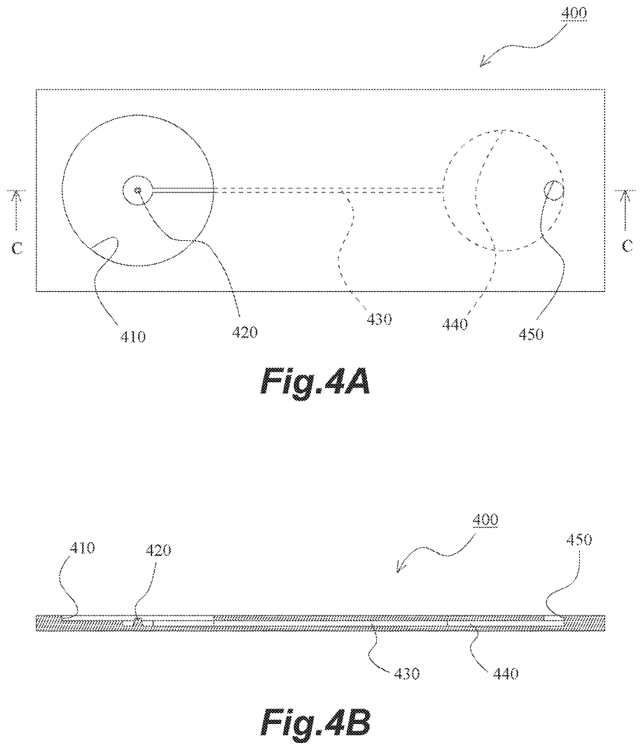

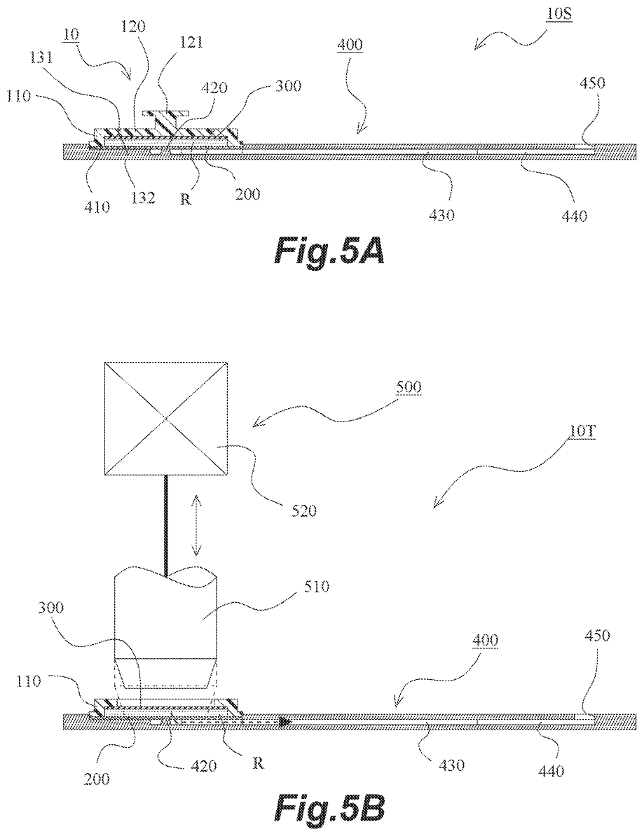

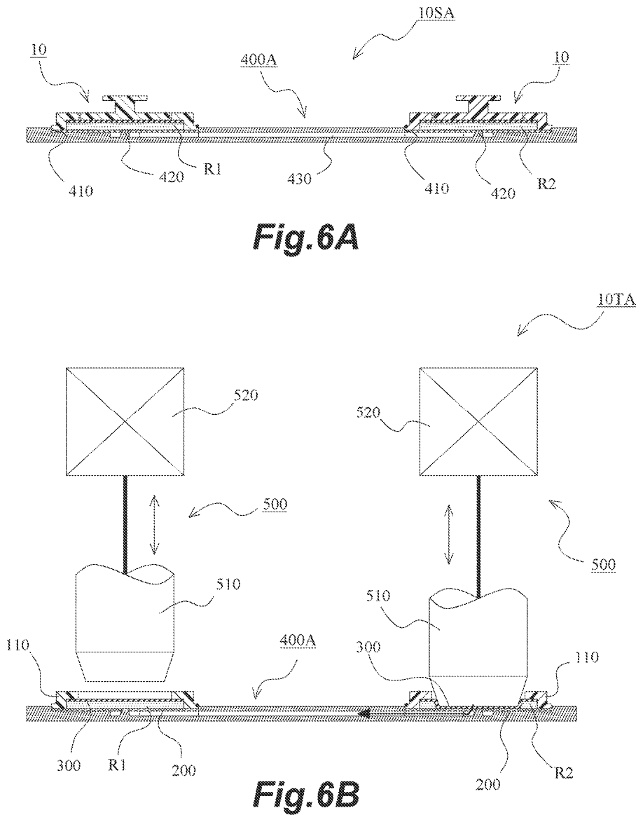

A container, a microfluidic device, and a diaphragm pump according to a first embodiment of the present disclosure will be described with reference to FIGS. 1 to 6. FIGS. 1A and 1B are schematic views of a container according to the first embodiment of the present disclosure. Note that FIG. 1A is a plan view of the container according to this embodiment, and FIG. 1B is a back surface view thereof. FIG. 2 is a schematic sectional view of the container according to the first embodiment of the present disclosure, and a sectional view taken along a plane indicated by AA in FIG. 1A. FIGS. 3A and 3B are schematic views showing the container in use according to the first embodiment of the present disclosure. Note that FIG. 3A is a plan view showing a state in which a lid of the container according to this embodiment has been removed, and FIG. 3B is a sectional view taken along a plane indicated by BB in FIG. 3A. FIGS. 4A and 4B are schematic views of a microfluidic chip to which the container according to the first embodiment of the present disclosure can be applied. Note that FIG. 4A is a plan view of the microfluidic chip to which the container according to this embodiment can be applied, and FIG. 4B is a sectional view taken along a plane indicated by CC in FIG. 4A. FIGS. 5A and 5B are schematic views of a microfluidic device and a diaphragm pump (application example 1) to which the container according to the first embodiment of the present disclosure can be applied. Note that FIG. 5A is a schematic sectional view of the microfluidic device to which the container according to this embodiment can be applied, and the container in this figure is that is shown in FIG. 2 and the microfluidic chip in this figure is that is shown in FIG. 4B. Further, FIG. 5B is a schematic view of the pump to which the container according to this embodiment can be applied, and the container in this figure is that is shown in FIG. 3B and the microfluidic chip in this figure is that is shown in FIG. 4B. FIGS. 6A and 6B are schematic views of a microfluidic device and a diaphragm pump (application example 2) to which the container according to the first embodiment of the present disclosure can be applied. Note that FIG. 6A is a schematic sectional view of the microfluidic device to which the container according to this embodiment can be applied, and the container in this figure is that is shown in FIG. 2. Further, FIG. 6B is a schematic view of the pump to which the container according to this embodiment can be applied, and the container in this figure is that is shown in FIG. 3B.

### <Container>

Referring specifically to FIGS. 1 to 3, a container 10 according to this embodiment will be described. The container 10 includes a case 100. The material of the case 100 may be selected in accordance with a fluid R to be sealed in the case 100. For example, when the fluid R is volatile, the material used for the case 100 may be a resin material having a superior gas barrier property. More specifically, polyvinylidene chloride, ethylene vinyl alcohol copolymer resin, and so on can be used as appropriate. Alternatively, a multilayer structure may be used which includes layers of these resin materials having the superior gas barrier properties. The case 100 includes a case body 110 including a tubular portion, a lid 120, and a handle 121, these components being formed integrally. In this embodiment, the tubular portion of the case body 110 is constituted by a cylindrical part.

Further, the container 10 includes a thin film 200 that closes an opening on one end side of the tubular portion of the case body 110. The material of the thin film 200 may be selected in accordance with the fluid R sealed in the case 100. For example, when the fluid R is volatile, the material used for the thin film 200 may be a material having a superior gas barrier property. For example, the thin film 200 may be formed from a single-layer film constituted by an aluminum film, a plastic film, or the like, or a multilayer film formed from these materials.

Furthermore, the container 10 includes a diaphragm 300 that closes an opening on the other end side of the tubular portion of the case body 110. The diaphragm 300 may be formed from an elastomer material, and more specifically, silicone rubber, which exhibits superior chemical stability and biocompatibility, may be used. By using silicone rubber, target cells can be protected.

In the container 10 configured as described above, an enclosed space is formed by the tubular portion of the case body 110, the thin film 200, and the diaphragm 300. The fluid R, such as a sample or a reagent, is sealed in the interior of the enclosed space. Note that the fluid R can be sealed in the interior of the enclosed space by pouring the fluid R into the case body 110 in a state where the diaphragm 300 is provided therein, and then attaching the thin film 200.

The lid 120 is provided on the other end side of the case body 110 on a side opposite to the thin film 200 with respect to the diaphragm 300 in order to close off the diaphragm 300 from the outside space. Thus, even if the diaphragm 300 is gas-permeable, volatilization of the fluid R in the enclosed space can be suppressed.

Furthermore, as described above, the lid 120 is provided integrally with the case body 110. A boundary between the lid 120 and the case body 110 is constituted by a thin part. More specifically, the thin part is formed by providing grooves 131 and 132 having circular shapes in plan view in front and rear surfaces, respectively. Thus, when the thin part is torn, the lid 120 is removed from the case body 110. Hence, the lid 120 is removable from the case body 110. In this embodiment, the handle 121 to be pulled in order to tear the thin part is provided on the lid 120, and by pulling the handle 121, a user can tear the thin part and thus remove the lid 120 from the case body 110. As a result, the diaphragm 300 can be exposed at the time of use. Note that FIGS. 3A and 3B show a state in which the lid 120 has been removed from the case body 110.

### Microfluidic Chip (Application Example 1)

Referring to FIGS. 4A and 4B in particular, a microfluidic chip 400 to which the container 10 according to this embodiment can be applied will be described. Note that in FIG. 4A, parts visible in transparent view are indicated by dotted lines.

The microfluidic chip 400 is a thin plate-shaped member formed from acrylic, glass, a resin material, or the like. The microfluidic chip 400 is provided with a recessed portion 410 serving as an attachment portion to which the case body 110 of the container 10 can be attached. An inner wall surface of the recessed portion 410 is constituted by a columnar surface and is configured such that the outer peripheral surface of the tubular portion of the case body 110 can be fitted thereto.

A projecting portion 420 for puncturing the thin film 200 of the container 10 is provided on the microfluidic chip 400 in the center of the bottom surface of the recessed portion 410. Further, a flow passage 430 for the fluid R is provided in the microfluidic chip 400 so as to connect to the recessed portion 410. Furthermore, the microfluidic chip 400 is provided with a storage tank 440 connected to the flow passage 430, and an extraction port 450 through which the fluid R is extracted.

### <Microfluidic Device and Diaphragm Pump (Application Example 1)>

Referring to FIGS. 5A and 5B, an example application (application example 1) of a microfluidic device and a diaphragm pump to which the container 10 according to this embodiment can be applied will be described.

FIG. 5A shows a microfluidic device 10S according to application example 1. The microfluidic device 10S is constituted by the microfluidic chip 400 and the container 10. Note that in this application example, the microfluidic chip 400 shown in FIGS. 4A and 4B and described above is used. The microfluidic device 10S can be obtained by fitting the case body 110 into the recessed portion 410 of the microfluidic chip 400 so as to attach the container 10 to the microfluidic chip 400. When the container 10 is attached to the microfluidic chip 400, the projecting portion 420 punctures the thin film 200 of the container 10, thereby forming an outflow port for the fluid R.

FIG. 5B shows a diaphragm pump 10T according to application example 1. The diaphragm pump 10T includes the microfluidic device 10S and a pressing mechanism 500. When the microfluidic device 10S is to be used as the diaphragm pump 10T, the lid 120 is removed from the case body 110. The pressing mechanism 500 includes a pressing member 510 for pressing the diaphragm 300 of the container 10, and an actuator 520 for causing the pressing member 510 to perform a reciprocating motion. Note that any of various known techniques, such as a ball screw mechanism, a rack and pinion mechanism, a hydraulic mechanism, or a pneumatic mechanism, may be employed as the actuator 520. As to the pressing member 510 in FIG. 5B, the solid lines indicate a state in which the pressing member 510 is separated from the diaphragm 300, while the dotted lines indicate a state in which the pressing member 510 is pressed against the diaphragm 300. When the diaphragm 300 is pressed by the pressing member 510, the fluid R sealed inside the container 10 is supplied to the flow passage 430 of the microfluidic chip 400 through the outflow port formed in the thin film 200 as indicated by the dotted arrow. Note that when the pressing member 510 is separated from the diaphragm 300, the diaphragm 300 returns to its original state. Thus, an operation for causing the fluid R to flow back can also be performed.

### Microfluidic Device and Diaphragm Pump (Application Example 2)

Referring to FIGS. 6A and 6B, an example application (application example 2) of a microfluidic device and a diaphragm pump to which the container 10 according to this embodiment can be applied will be described.

FIG. 6A shows a microfluidic device 10SA according to application example 2. The microfluidic device 10SA is constituted by a microfluidic chip 400A and the container 10. The microfluidic chip 400A, according to this application example, employs a different configuration from the microfluidic chip 400 shown in FIGS. 4A and 4B and described above. The microfluidic chip 400A, similarly to the microfluidic chip 400 described above, includes the recessed portion 410 serving as the attachment portion, the projecting portion 420, and the flow passage 430. In contrast to the microfluidic chip 400 described above, in the microfluidic chip 400A according to application example 2, the recessed portion 410 and the projecting portion 420 are provided on both sides of the flow passage 430, while the storage tank 440 and the extraction port 450 are not provided. Note, however, that a ventilation port, not shown in the figures, that is used to allow air and the like to escape from the flow passage 430 and so on is provided in the microfluidic chip 400A.

In this application example, the microfluidic device 10SA can be obtained by fitting the case body 110 into each of the recessed portions 410 provided in two locations of the microfluidic chip 400A such that two containers 10 are attached. When the two containers 10 are attached to the microfluidic chip 400A, the projecting portions 420 puncture the thin films 200 of the respective containers 10, thereby respectively forming outflow ports for fluids R1 and R2.

FIG. 6B shows a diaphragm pump 10TA according to application example 2. The diaphragm pump 10TA includes the microfluidic device 10SA and a pair of pressing mechanisms 500. When the microfluidic device 10SA is used as the diaphragm pump 10TA, the lid 120 is removed from the case body 110. The pressing mechanism 500 is configured as described in the application example 1. In this application example, by pressing the diaphragms 300 of the two containers 10 alternately using the two pressing mechanisms 500, for example, the fluids R1 and R2 can be caused to move through the flow passage 430 in a reciprocating manner. When different samples or reagents are used as the fluid R1 and the fluid R2, the fluids can be mixed.

### Advantages of Container, Microfluidic Device, and Diaphragm Pump According to this Embodiment

With the container 10 according to this embodiment, by pressing the diaphragm 300 in a state where the outflow port has been formed in the thin film 200, the fluid sealed inside the case body 110 can be caused to flow out. Further, since the fluid is caused to flow out by pressing the diaphragm 300, the outflow rate of the fluid can be controlled more easily than a configuration in which a container that undergoes plastic deformation is used. Furthermore, the container 10 can also be caused to function as part of the diaphragm pump 10T, 10TA.

In a state prior to use, the lid 120 is provided on the case 100 of the container 10, and therefore the diaphragm 300 is not exposed to the outside during storage or transportation of the container 10. This can prevent leakage of the fluid due to damage to the diaphragm 300 or the diaphragm 300 being pressed. Moreover, the lid 120 is removable from the case body 110, and when the container 10 is used as the diaphragm pump 10T, 10TA, the lid 120 need simply to be removed from the case body 110. Furthermore, in this embodiment, the lid 120 can easily be removed from the case body 110 by pulling the handle 121. Moreover, even when the diaphragm 300 is gas-permeable, by forming the case 100 and the thin film 200 from materials having a gas barrier property, volatilization of the fluid R in the enclosed space can be suppressed prior to use.

Further, the fluid sealed inside the container 10 can be supplied to the flow passage 430 of the microfluidic chip 400, 400A simply by attaching the container 10 to the microfluidic chip 400, 400A. This saves space and reduces the number of components.

Furthermore, the microfluidic device 10S, 10SA according to this embodiment can be obtained by attaching the container 10 to the microfluidic chip 400, 400A. The fluid R sealed inside the container 10 can be supplied to the flow passage 430 provided in the microfluidic chip 400, 400A immediately after attaching the container 10, and this can prevent foreign matter from entering the fluid R.

### Second Embodiment

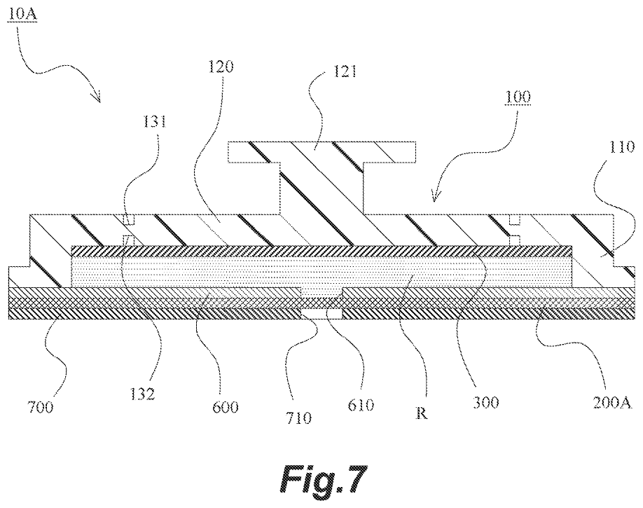

Referring to FIG. 7, a container according to a second embodiment of the present disclosure will be described. The configuration of the container of this embodiment partially differs from that of the first embodiment. The basic configuration and operations are identical to the first embodiment, and therefore identical constituent parts have been allocated identical reference numerals and description thereof has been omitted where appropriate. FIG. 7 is a schematic sectional view of the container according to the second embodiment of the present disclosure, which is obtained by cutting the container in the same location as the sectional view shown in FIG. 2 in the first embodiment.

A container 10A according to this embodiment includes the case 100, a thin film 200A, and the diaphragm 300. The case 100 and the diaphragm 300 are as described in the first embodiment.

In this embodiment, the configuration of the thin film 200A itself is as described in the first embodiment, but the structure for attaching the thin film 200A to the case body 110 differs from the first embodiment. In this embodiment, the thin film 200A is sandwiched between a first guide member 600 and a second guide member 700 respectively having through holes 610 and 710 through which the projecting portion 420 of the microfluidic chip 400 or 400A can be inserted. The first guide member 600 is provided on the diaphragm 300 side, and the second guide member 700 is provided on a side opposite to the first guide member 600 with respect to the thin film 200A. The first guide member 600 is fixed to the case body 110. Further, the first guide member 600 is formed from a hard material (a hard resin material or the like), while the second guide member 700 is formed from an elastomer material such as rubber. Note that the container 10A according to this embodiment can be used in place of the container 10 in the microfluidic device and diaphragm pump described in the first embodiment.

Similar effects to the first embodiment can be obtained with the container 10A configured as described above. Moreover, with the container 10A according to this embodiment, when the container 10A is attached to the microfluidic chip, positional deviation of the projecting portion 420 is suppressed by the through holes 610 and 710, and therefore the operation for puncturing the thin film 200A with the projecting portion 420 is performed smoothly. Furthermore, since the first guide member 600 is formed from a hard material, sufficient force can be applied when the container 10A is attached to the microfluidic chip. This prevents the container 10A from being insufficiently attached. Moreover, by forming the second guide member 700 from an elastomer material such as rubber, the second guide member 700 can be brought into close contact with the bottom surface of the recessed portion 410 of the microfluidic chip 400 or 400A. This prevents leakage of the fluid to the outside.

### Third Embodiment

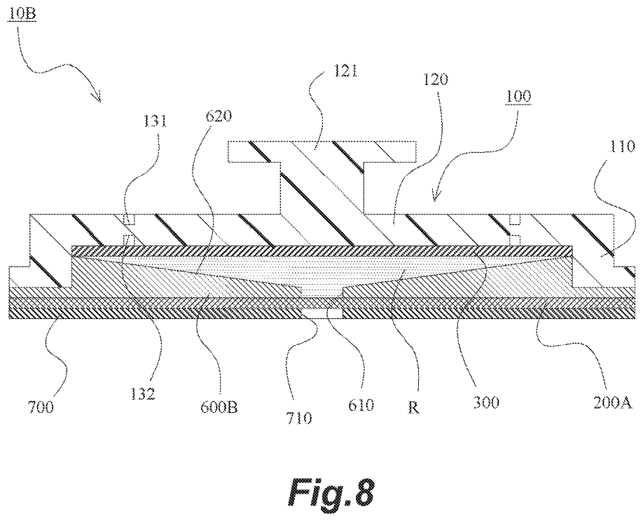

Referring to FIG. 8, a container according to a third embodiment of the present disclosure will be described. The shape of the first guide member of this embodiment differs from that of the second embodiment. The basic configuration and operations are identical to the second embodiment, and therefore identical constituent parts have been allocated identical reference numerals and description thereof has been omitted where appropriate. FIG. 8 is a schematic sectional view of the container according to the third embodiment of the present disclosure, which is obtained by cutting the container in the same location as the sectional view shown in FIG. 2 in the first embodiment.

A container 10B according to this embodiment includes the case 100, the thin film 200A, and the diaphragm 300. The case 100 and the diaphragm 300 are as described in the first embodiment.

In this embodiment, the configuration of the thin film 200A itself is as described in the first embodiment, but the structure for attaching the thin film 200A to the case body 110 differs from the first embodiment. In this embodiment, the thin film 200A is sandwiched between a first guide member 600B and the second guide member 700 respectively having the through holes 610 and 710 through which the projecting portion 420 of the microfluidic chip 400 or 400A can be inserted. The first guide member 600B is provided on the diaphragm 300 side, and the second guide member 700 is provided on a side opposite to the first guide member 600 with respect to the thin film 200A. The first guide member 600B is fixed to the case body 110. Further, the first guide member 600B is formed from a hard material (a hard resin material or the like), while the second guide member 700 is formed from an elastomer material such as rubber. Note that the container 10B according to this embodiment can be used in place of the container 10 in the microfluidic device and diaphragm pump described in the first embodiment.

In the first guide member 600B according to this embodiment, a surface 620 thereof on the diaphragm 300 side is formed from an inclined surface that decreases in diameter toward the through hole 610. Note that in this embodiment, the inclined surface is constituted by a tapered surface, but a configuration other than a tapered surface (for example, an inclined surface that is curved rather than linear in a sectional view) may be employed as the inclined surface.

Similar effects to the first and second embodiments can be obtained with the container 10B configured as described above. Moreover, in this embodiment, the surface 620 on the diaphragm 300 side is formed from an inclined surface, and therefore, when the diaphragm 300 is pressed such that the fluid R flows out, fluid can be prevented from remaining inside the container.

Furthermore, it was found through verification that, depending on the use conditions, no problems occurred in terms of quality in the container 10B according to this embodiment even if the second guide member 700 was omitted. Accordingly, a container configured not to include the second guide member 700 among the components of the container 10B can also be employed.

### (Miscellaneous)

Configurations in which the case 100 includes the lid 120 were illustrated in the embodiments described above. However, depending on the type of the sealed fluid R, the material of the diaphragm 300, and the storage and transportation conditions, the lid 120 may be omitted. Hence, depending on various conditions, the lid 120 of the case 100 may not be included, and a configuration not including the lid 120 may be employed in the case 100.

### REFERENCE SIGNS LIST

10, 10A, 10B Container
10S, 10SA Microfluidic device
10T, 10TA Diaphragm pump
100 Case
110 Case body
120 Lid
121 Handle
131, 132 Groove
200, 200A Thin film
300 Diaphragm
400, 400A Microfluidic chip
410 Recessed portion
420 Projecting portion
430 Flow passage
440 Storage tank
450 Extraction port
500 Pressing mechanism
510 Pressing member
520 Actuator
610, 710 Through hole
R, R1, R2 Fluid

1. A container comprising:
a case body that includes a tubular portion in which a fluid is to be sealed;
a thin film that closes an opening on one end side of the tubular portion, and that is to be punctured so as to form an outflow port for the fluid therein; and
a diaphragm that closes an opening on the other end side of the tubular portion.

2. The container according to claim 1, wherein, on the other end side of the case body, a lid that closes off the diaphragm from an outside space is provided on a side opposite to the thin film with respect to the diaphragm.

3. The container according to claim 2, wherein the lid is provided integrally with the case body, a boundary between the lid and the case body is constituted by a thin part, and the lid is removable from the case body by tearing the thin part.

4. The container according to claim 3, wherein a handle to be pulled to tear the thin part is provided on the lid.

5. The container according to claim 1, wherein the case body is formed from a material having a gas barrier property.

6. The container according to claim 1, wherein the thin film is formed from a material having a gas barrier property.

7. The container according to claim 1, wherein the diaphragm is formed from an elastomer material.

8. The container according to claim 1, wherein the container is attached to a microfluidic chip comprising an attachment portion to which the case body is attached, a projecting portion for puncturing the thin film, and a flow passage for the fluid.

9. The container according to claim 8, wherein the thin film is sandwiched between a first guide member and a second guide member, each of which has a through hole through which the projecting portion is inserted, the first guide member being provided on the diaphragm side and the second guide member being provided on a side opposite to the first guide member with respect to the thin film.

10. The container according to claim 9, wherein the fluid is sealed in a space between the diaphragm and the first guide member, and a surface of the first guide member on the diaphragm side is constituted by an inclined surface that decreases in diameter toward the through hole.

11. The container according to claim 9, wherein the first guide member is formed from a hard material and the second guide member is formed from an elastomer material.

12. The container according to claim 8, wherein
a guide member having a through hole through which the projecting portion is inserted is provided between the case body and the thin film,
the fluid is sealed in a space between the diaphragm and the guide member, and
a surface of the guide member on the diaphragm side is constituted by an inclined surface that decreases in diameter toward the through hole.

13. A microfluidic device comprising:
a microfluidic chip including an attachment portion to which a case body is attached, a projecting portion for puncturing the thin film, and a flow passage for the fluid; and
the container according to claim 1, which is attached to the microfluidic chip by attaching the case body to the attachment portion.

14. A diaphragm pump comprising:
the microfluidic device according to claim 13;
a pressing member configured to press the diaphragm; and
an actuator configured to cause the pressing member to perform a reciprocating motion.
